(19) United States
(12) Patent Application Publication
(10) Pub. No.: US 2004/0252500 A1
(43) Pub. Date: Dec. 16, 2004

(54) Strip light with constant current

(76) Inventor: Yuan Lin, Doncaster East (AU)

Correspondence Address: BRUCE H. TROXELL, SUITE 1404, 5205 LEESBURG PIKE, FALLS CHURCH, VA, 22041, US

(21) Appl. No.: 10/717,493

(22) Filed: Nov. 21, 2003

(30) Foreign Application Priority Data
Jun. 13, 2003 (TW) 092116189

(51) Int. Cl. F21V 21/00

(52) U.S. Cl. 362/236; 362/391; 362/800

(57) ABSTRACT

A strip light is disclosed. The light comprises an illuminating unit including a plurality of illuminators (e.g., LEDs) directly and electrically coupled in series, and a constant current stabilization unit for supplying a constant current to each illuminator. A number of embodiments of the constant current stabilization unit are made possible. The invention further has advantages of energy saving, even brightness of the illuminators, less heat generation, and durability.

### BACKGROUND OF THE INVENTION

1. Field of the Invention

The present invention relates to strip lights and more particularly to such a strip light having an arrangement for supplying a constant current to each illuminator thereof.

2. Description of Related Art

A conventional LED based strip light is disclosed in Taiwanese Patent Published No. 516,709 (the prior art). The prior art comprises a plurality of LEDs (light emitting diodes) mounted on a circuit board, a plurality of resistors coupled to each of the LEDs on the circuit board, two diodes at both ends of the circuit board, a positive terminal at one end of the circuit board for coupling to another LED based strip light or power source, a negative terminal at the other end of the circuit board for coupling a positive terminal of another LED based strip light or power source, upper insulation means for enclosing the LEDs, the resistors, the diodes, and the positive and the negative terminals on a top surface of the circuit board, and lower insulation means for enclosing pins, contacts, and circuits on a bottom surface of the circuit board.

The prior art is adapted to regulate current. However, the prior art suffered from several disadvantages. For example, high heat can be generated by a LED and its coupled resistor. Such heat may be excessively high if the number of LEDs and thus the number of resistors are large (i.e., many LEDs and resistors are coupled in series). Also, brightness of the LEDs can be lowered due to increased resistance. In other words, a considerable portion of electrical energy is consumed (i.e., wasted) by resistors rather than by LEDs. Further, brightness of one LED may be different from that of other LEDs due to uneven resistor in respective LEDs. This is not desirable. Thus, the need for improvement still exists.

### SUMMARY OF THE INVENTION

It is an object of the present invention to provide a strip light having an arrangement for supplying a constant current to each illuminator (e.g., LED) thereof.

It is another object of the present invention to provide a strip light having a constant current stabilization arrangement so as to obtain advantages of energy saving, even brightness of LEDs, less heat generation, and durability.

The above and other objects, features and advantages of the present invention will become apparent from the following detailed description taken with the accompanying drawings.

### BRIEF DESCRIPTION OF THE DRAWINGS

FIG. 1 is a circuit diagram of a first preferred embodiment of strip light according to the invention;

FIG. 2 is a circuit diagram of a second preferred embodiment of strip light according to the invention;

FIG. 2A is a perspective view of the strip light shown in FIG. 2;

FIG. 2B schematically depicts the electrical connection of a third preferred embodiment of strip light according to the invention;

FIGS. 2C, 2D, 2E, and 2F are top plan views of constant current stabilization unit according to fourth, fifth, sixth, and seventh preferred embodiments of the invention respectively;

FIG. 2G schematically depicts the electrical connection of an eighth preferred embodiment of strip light according to the invention;

FIG. 3 is a circuit diagram of a ninth preferred embodiment of strip light according to the invention;

FIG. 4 is a circuit diagram of a tenth preferred embodiment of strip light according to the invention;

FIG. 5 is a perspective view of the strip light shown in FIG. 4; and

FIG. 6 schematically depicts the electrical connection of an eleventh preferred embodiment of strip light according to the invention.

### DETAILED DESCRIPTION OF THE PREFERRED EMBODIMENTS

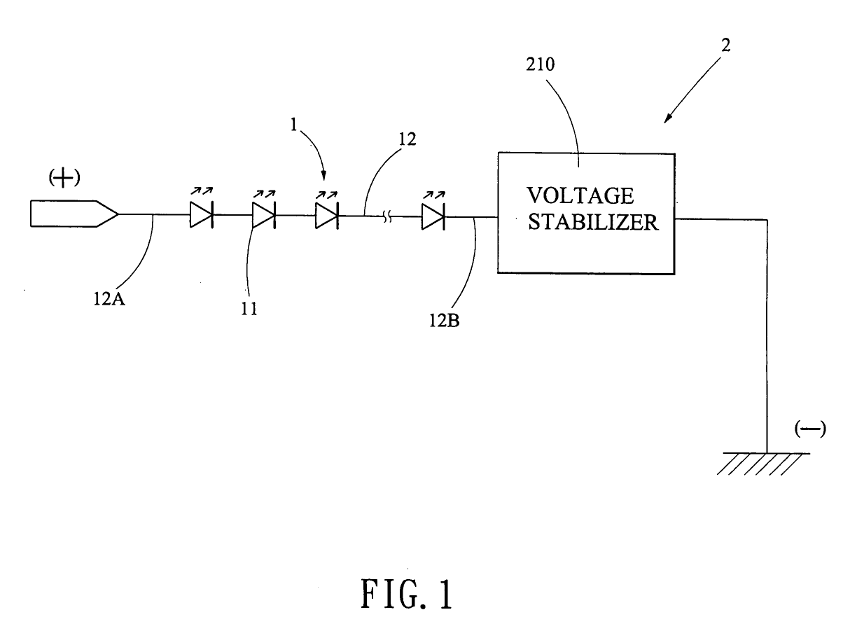

Referring to FIG. 1, there is shown a first preferred embodiment of strip light constructed in accordance with the invention. The strip light is electrically coupled to a power source by a wire 12A. The strip light comprises an illuminating unit 1 including a plurality of illuminators 11 directly and electrically coupled in series by a wire 12, and a wire 12B; and a constant current stabilization unit 2 including a voltage stabilizer 210 electrically coupled to the wire 12B and a current regulator 220 interconnected the voltage stabilizer 210 and ground. By configuring as above, a constant current can be supplied to each LED 11. The illuminator 11 is implemented as a LED (as shown in this and following embodiments) or bulb. The voltage stabilizer 210 is implemented as a conventional circuit, a semiconductor device, or an IC (integrated circuit).

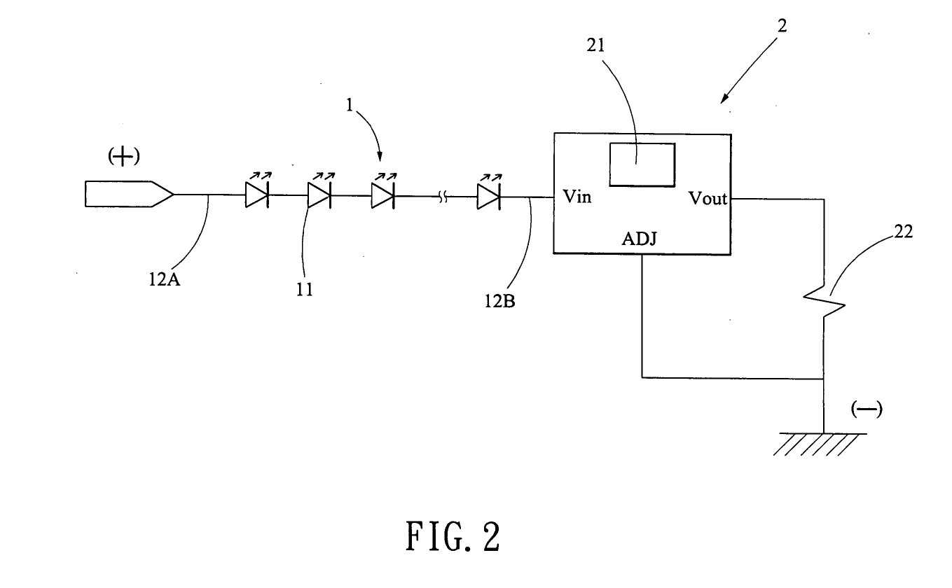

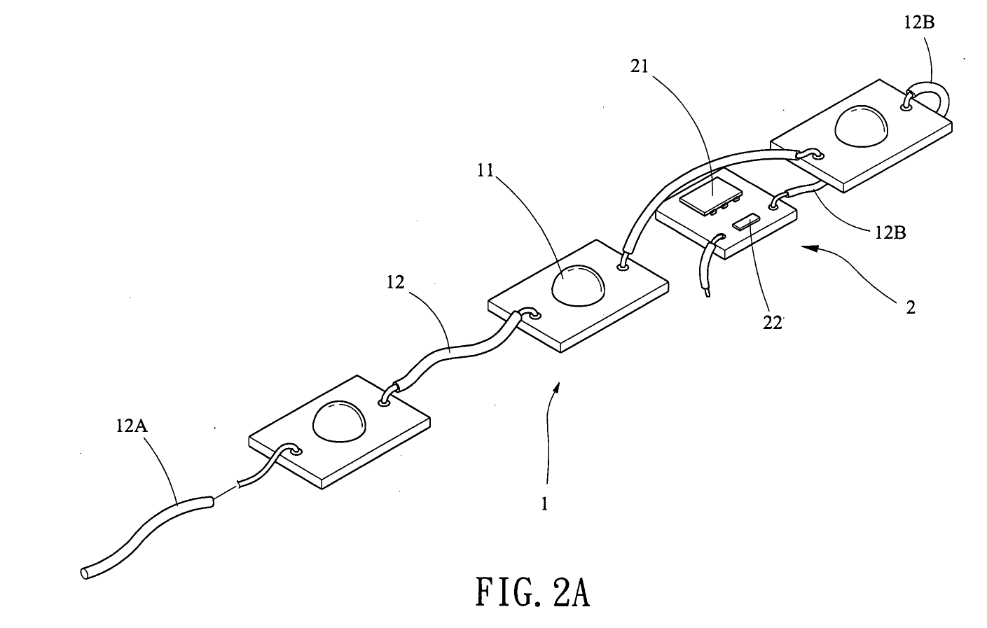

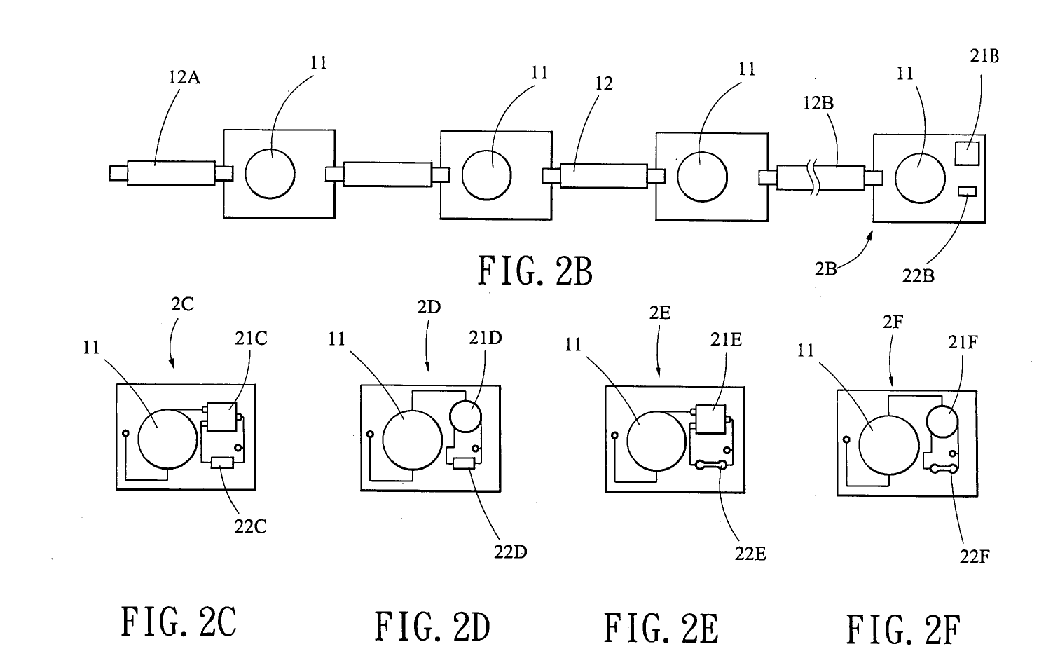

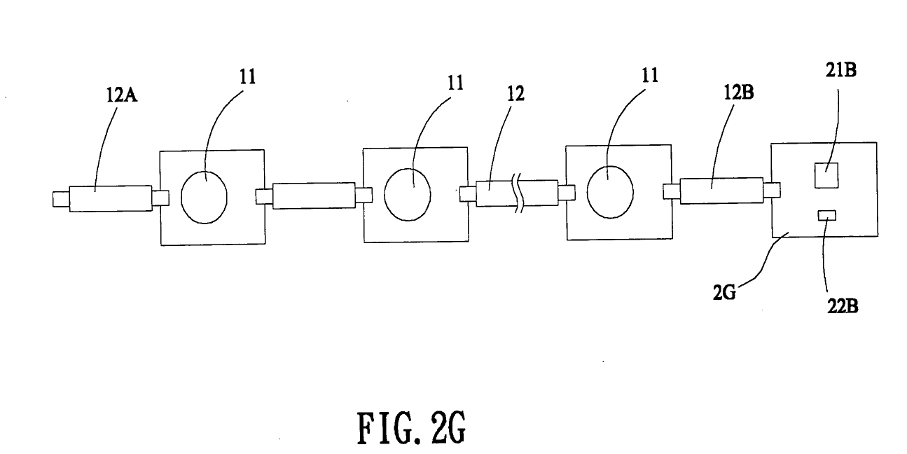

Referring to FIGS. 2 and 2A, a second preferred embodiment of the invention is shown. The second preferred embodiment is characterized in the constant current stabilization unit 2 as detailed below. The constant current stabilization unit 2 comprises a voltage stabilizer 21 and a current regulator 22 having one end coupled to the voltage stabilizer 21 and the other end coupled to ground. The current regulator 22 is implemented as a resistor. The power source is adapted to supply a voltage in the range of 2.1V to 36V. Thus, the voltage stabilizer 21 is implemented as an LM317 IC based voltage stabilizer in the embodiment. The wire 12B is electrically coupled to an input terminal (Vin) of the voltage stabilizer 21. An output terminal (Vout) of the voltage stabilizer 21 is electrically coupled to the current regulator 22 and an adjustment terminal (ADJ) thereof is coupled to ground. By configuring as above, a constant current can be supplied to each LED 11. Note that the current regulator 22 can be incorporated as part of the voltage stabilizer 21 or even eliminated if the length of the illuminating unit 1 is fixed or the number of the LEDs 11 is fixed.

Referring to FIG. 2B, it schematically depicts the electrical connection of a third preferred embodiment of strip light according to the invention. One of the illuminators 11 (e.g., the right one as shown) is implemented as a COB (chip on board) type LED 11 mounted on a constant current stabilization unit 2B. The constant current stabilization unit is implemented as a COB type constant current stabilization unit 2B. Also, the voltage stabilizer is implemented as a COB type voltage stabilizer 21B and the current regulator is implemented as a COB type current regulator 22B. The COB type LED 11 is electrically coupled to the COB type voltage stabilizer 21B and the COB type current regulator 22B in series. The wires of flat metal foil type 12, 12A, and 12B having a relatively larger flat cross-sectional area, coupled to the LEDs 11, are capable of permitting a relatively large current to pass therethrough. The wire 12B is coupled between the COB type LED 11 and the adjacent LED 11.

Referring to FIG. 2C, a top plan view of a constant current stabilization unit 2C according to a fourth preferred embodiment of the invention is shown. The constant current stabilization unit 2C has the same characteristics as the constant current stabilization unit 2B except that the former comprises a SMD (surface mounting) type voltage stabilizer 21C and a SMD type current regulator 22C. Also, the COB type LED 11, the SMD type voltage stabilizer 21C, and the SMD type current regulator 22C are formed on the same circuit board and are electrically coupled together.

Referring to FIG. 2D, a top plan view of a constant current stabilization unit 2D according to a fifth preferred embodiment of the invention is shown. The constant current stabilization unit 2D has the same characteristics as the constant current stabilization unit 2B except that the former comprises a bare dice encapsulation type voltage stabilizer 21D and a SMD type current regulator 22D. Also, the COB type LED 11, the voltage stabilizer 21D, and the current regulator 22D are formed on the same circuit board and are electrically coupled together.

Referring to FIG. 2E, a top plan view of a constant current stabilization unit 2E according to a sixth preferred embodiment of the invention is shown. The constant current stabilization unit 2E has the same characteristics as the constant current stabilization unit 2B except that the former comprises a SMD type voltage stabilizer 21E and a printed carbon film type current regulator 22E. Also, the COB type LED 11, the SMD voltage stabilizer 21E, and the printed carbon film type current regulator 22E are formed on the same circuit board and are electrically coupled together.

Referring to FIG. 2F, a top plan view of a constant current stabilization unit 2F according to a seventh preferred embodiment of the invention is shown. The constant current stabilization unit 2F has the same characteristics as the constant current stabilization unit 2B except that the former comprises a bare dice encapsulation type voltage stabilizer 21F and a printed carbon film type current regulator 22F. Also, the COB type LED 11, the bare dice encapsulation type voltage stabilizer 21F, and the printed carbon film type current regulator 22F are formed on the same circuit board and are electrically coupled together.

Referring to FIG. 2G, it schematically depicts the electrical connection of an eighth preferred embodiment of strip light according to the invention. This preferred embodiment substantially has same structure as the third preferred embodiment. The differences between these two preferred embodiments, i.e., the characteristics of the eighth preferred embodiment are detailed below. The COB type LED 11 is eliminated from a constant current stabilization unit 2G which comprises a COB type voltage stabilizer 21B and a COB type current regulator 22B.

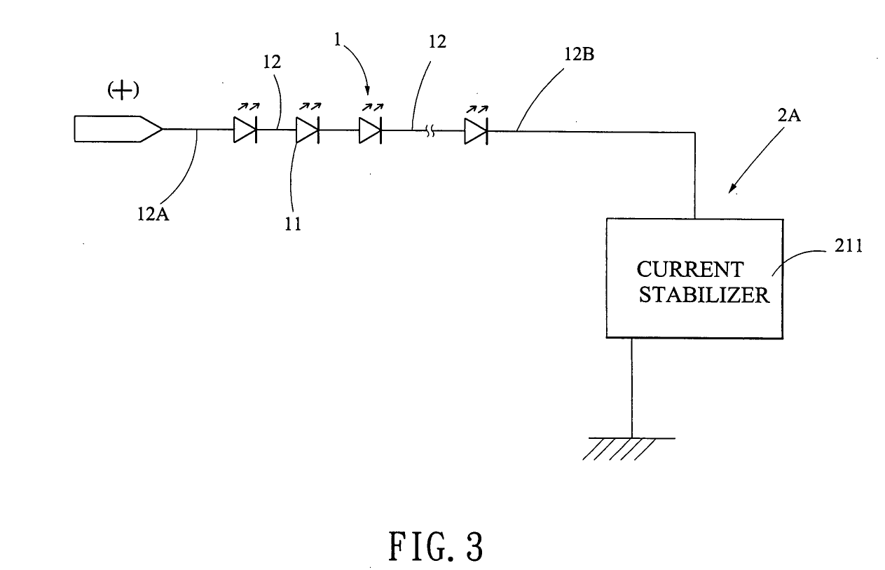

Referring to FIG. 3, there is shown a circuit diagram of a ninth preferred embodiment of strip light according to the invention. This preferred embodiment substantially has same structure as the first preferred embodiment except that the current regulator of the constant current stabilization unit 2A is eliminated and the voltage stabilizer 210 is replaced by a current stabilizer 211. Further, the current stabilizer 211 is coupled to ground directly.

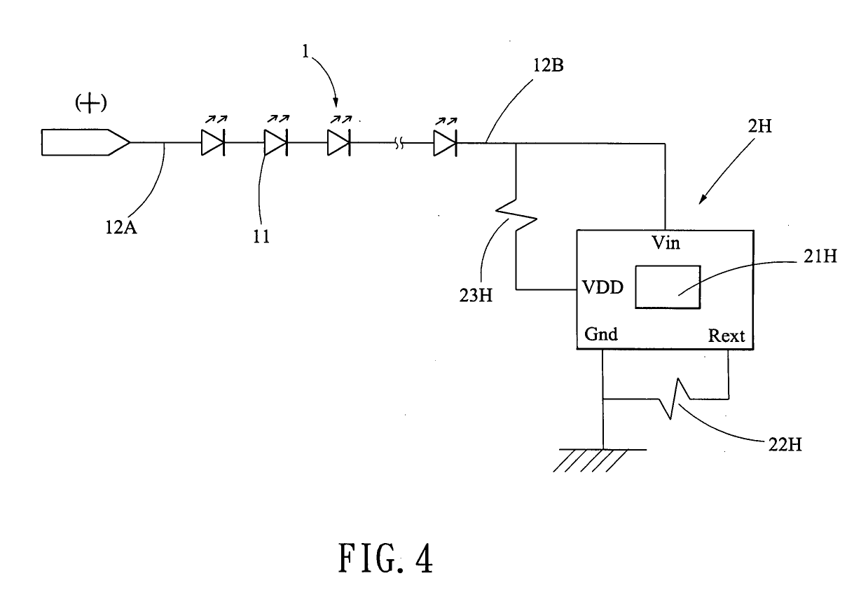

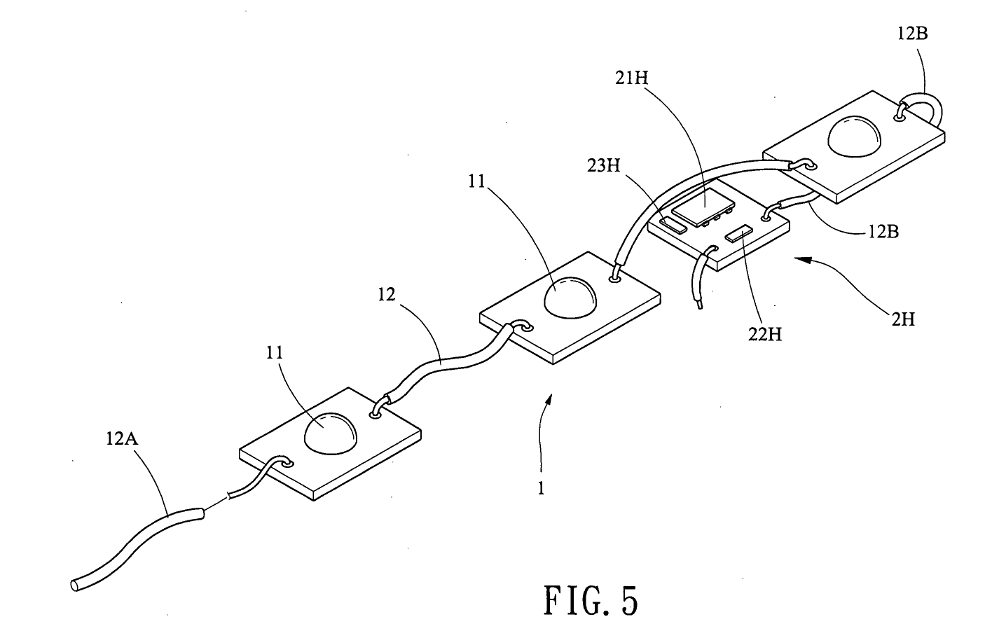

FIGS. 4 and 5, there is shown a tenth preferred embodiment of strip light according to the invention. The tenth preferred embodiment is characterized in a constant current stabilization unit 2H as detailed below. In this embodiment, the power source may be adapted to supply a voltage in a range of 3V to 260V. The constant current stabilization unit 2H comprises a voltage stabilizer 21H, a first current regulator 22H interconnected a current regulation terminal (Rext) of the constant current stabilization unit 2H and ground in which the first current regulator 22H is also coupled to a ground (Gnd) terminal of the constant current stabilization unit 2H, and a second current regulator 23H interconnected the wire 12B and a voltage terminal (VDD) of the constant current stabilization unit 2H in which the wire 12B is also coupled to an input terminal (Vin) of the constant current stabilization unit 2H. The first current regulator 22H is adapted to regulate current fed from the illuminating unit 1. According to this specific embodiment of the invention, the voltage stabilizer 21H is implemented as a DD231 IC based voltage stabilizer 21H. Hence, the second current regulator 23H is adapted to supply a predetermined current to VDD. The predetermined current is further stabilized by the DD231 IC based voltage stabilizer 21H to supply a constant current. In a case of resistance variation of the LED 11 or the brightness of the LED 11 being insufficient, the first current regulator 22H is adapted to regulate current to cause the constant current stabilization unit 2H to generate a constant current. In other words, a constant current is always supplied to each LED 11.

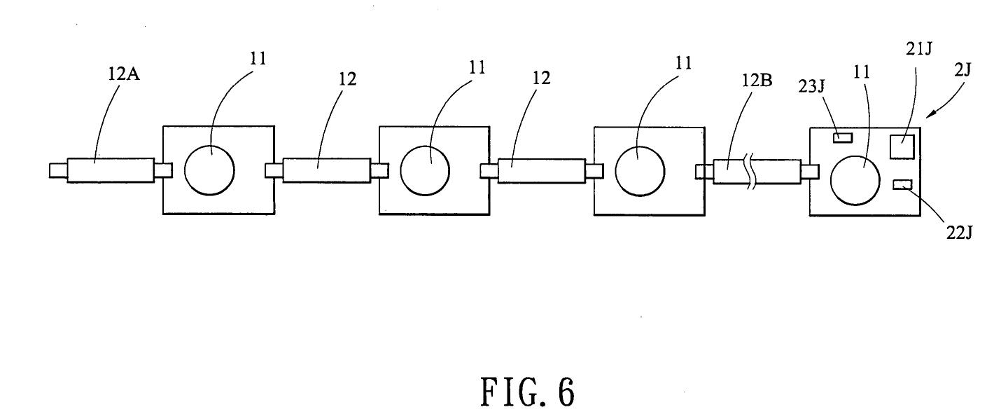

FIG. 6 schematically depicts the electrical connection of an eleventh preferred embodiment of strip light according to the invention. One of the illuminators 11 (e.g., the right one as shown) is implemented as a COB type LED mounted on a constant current stabilization unit 2J. The constant current stabilization unit is implemented as a COB type constant current stabilization unit 2J. Also, the voltage stabilizer is implemented as a COB type voltage stabilizer 21J and the current regulator is implemented as a COB type current regulator including a COB type first current regulator 22J and a COB type second current regulator 23J. The COB type LED 11 is electrically coupled to the COB type voltage stabilizer 21J and the COB type first and second current regulators 22J and 23J in series. The wires of flat metal foil type 12, 12A, and 12B having a relatively larger flat cross-sectional area, coupled to the LEDs 11, are capable of permitting a relatively large current to pass therethrough. The wire 12B is coupled between the COB type LED 11 and the adjacent LED 11.

In addition to the supplying of constant current to each LED 11, other benefits of the invention include energy saving, even brightness of the LEDs 11, less heat generation, and durability.

While the invention herein disclosed has been described by means of specific embodiments, numerous modifications and variations could be made thereto by those skilled in the art without departing from the scope and spirit of the invention set forth in the claims.

What is claimed is:

1. A strip light device, comprising:
an illuminating unit including a plurality of illuminators directly and electrically coupled in series; and
a constant current stabilization unit having one end electrically coupled to the illuminating unit and the other end coupled to ground,
wherein the constant current stabilization unit is operative to supply a constant current to each of the illuminators.

2. The strip light device of claim 1, wherein each of the illuminators is a LED or bulb.

3. The strip light device of claim 1, wherein the constant current stabilization unit is a voltage stabilizer.

4. The strip light device of claim 1, wherein the constant current stabilization unit comprises a voltage stabilizer and a current regulator.

5. The strip light device of claim 1, wherein the constant current stabilization unit is a current stabilizer.

6. The strip light device of claim 1, wherein the constant current stabilization unit comprises a current stabilizer and a current regulator.

7. The strip light device of claim 6, wherein the current regulator is resistor means.

8. The strip light device of claim 1, wherein the constant current stabilization unit is a COB type constant current stabilization unit including a COB type voltage stabilizer and a COB type current regulator.

9. The strip light device of claim 1, wherein the constant current stabilization unit comprises a SMD type voltage stabilizer and a SMD type current regulator.

10. The strip light device of claim 1, wherein the constant current stabilization unit comprises a bare dice encapsulation type voltage stabilizer and a SMD type current regulator.

11. The strip light device of claim 1, wherein the constant current stabilization unit comprises a SMD type voltage stabilizer and a printed carbon film type current regulator.

12. The strip light device of claim 1, wherein the constant current stabilization unit comprises a bare dice encapsulation type voltage stabilizer and a printed carbon film type current regulator.

13. The strip light device of claim 1, wherein the constant current stabilization unit is a COB type constant current stabilization unit mounted on a circuit board.

14. The strip light device of claim 2, wherein the constant current stabilization unit is a COB type constant current stabilization unit mounted on a circuit board, and the LED coupled to the constant current stabilization unit is a COB type LED mounted on the circuit board.

15. The strip light device of claim 1, wherein a wire between each of the two illuminators or between the illuminator and the constant current stabilization unit is of a flat metal foil type.
